(19) United States
(12) Patent Application Publication
(10) Pub. No.: US 2010/0155288 A1
(43) Pub. Date: Jun. 24, 2010

(54) MULTI-LAYER LAMINATE MATERIAL

(75) Inventors: Tim Harper, Shelbyville, KY (US); Joseph Wittemer, Shelbyville, KY (US)

Correspondence Address: BANNER & WITCOFF, LTD., TEN SOUTH WACKER DRIVE, SUITE 3000, CHICAGO, IL, 60606, US

(73) Assignee: ALCAN TECHNOLOGY & MANAGEMENT LTD, Neuhausen (CH)

(21) Appl. No.: 12/638,679

(22) Filed: Dec. 15, 2009

Related U.S. Application Data
(60) Provisional application No. 61/122,584, filed on Dec. 15, 2008.

(51) Int. Cl. B65D 83/04; B32B 9/04; B32B 15/04; B32B 23/04; B32B 15/08; B32B 23/08; B32B 15/00; B32B 27/32; B32B 27/34; B32B 37/12; A61J 1/03

(52) U.S. Cl. 206/531; 428/411.1; 428/457; 428/532; 428/461; 428/507; 428/464; 428/615; 428/523; 428/479.3; 428/474.4; 428/500; 156/60; 206/532

(57) ABSTRACT

A laminate material includes a substrate layer having first and second opposed sides, a first plastic layer located on the first side of the substrate layer, a second plastic layer located on the second side of the substrate layer, and at least one intermediate layer located on the first side and/or the second side of the substrate layer, between the first plastic layer and/or the second plastic layer and the substrate layer. The intermediate layer may be a single layer or multiple layers, and includes at least one of a metallized layer, a printing ink, a pigment, a toner, and/or a lacquer layer. The intermediate layer may further include at least one of a layer of primer and a layer of adhesive.

### CROSS-REFERENCE TO RELATED APPLICATION

The present application claims priority to, and the benefit of, U.S. Provisional Patent Application No. 61/122,584, filed on Dec. 15, 2008, which application is incorporated by reference herein in its entirety.

### TECHNICAL FIELD

The present invention relates to a multi-layer laminate material that is suitable for use in packaging purposes and other applications.

### BACKGROUND

For packaging purposes it is known to employ composite film-type laminates having different layers, for example, foils or films which are laminated together, such as by means of adhesives. Such laminates are employed in many applications, such as for the production of supports or base parts or for lid films for blister packs or push-through forms of packaging. To manufacture base parts, the laminates are provided with a number of recesses by means of deep-drawing, stretch drawing or a combination of both methods. The recesses are arranged uniformly or in groups and serve to accommodate various articles, including medicaments in the form of a pill, dragee, ampoule, capsule, etc. The base parts are closed off by a lid film which is adhesively bonded or sealed onto the shoulder region of the base part. The function and appearance of both the base parts and the lid films is often an important consideration in designing such packaging.

Prior and existing laminates have certain drawbacks and disadvantages in this regard, and in other regards, and there is a need in the art to address such drawbacks and disadvantages.

The present invention provides a laminate which can achieve superior function and appearance to existing laminates. The appearance or the colour plays an increasing role with regard to identification of the articles therein, such as medicaments or pharmaceutical packs which should be recognisable from a distance on racks and displays in pharmacies, druggists, and other means of distribution of medicaments and prescriptions.

### BRIEF SUMMARY

Aspects of the present invention relate to a laminate material that includes a substrate layer having first and second opposed sides, a first plastic layer located on the first side of the substrate layer, a second plastic layer located on the second side of the substrate layer, and at least one intermediate layer located on the first side and/or the second side of the substrate layer, between the first plastic layer and/or the second plastic layer and the substrate layer. The intermediate layer may be a single layer or multiple layers, and includes at least one of a metallized layer, a printing ink, a pigment, a toner, and a lacquer layer. The intermediate layer may further include a layer of primer and/or a layer of adhesive.

According to one aspect, the intermediate layer is located between the first side of the substrate layer and the first plastic layer, and the laminate further includes a second intermediate layer located between the second side of the substrate layer and the second plastic layer. The second intermediate layer includes at least one of a metallized layer, a printing ink, a pigment, a toner, a lacquer layer, a primer layer, and an adhesive layer.

According to another aspect, the substrate layer is an aluminum foil, the first plastic layer is an oriented polyamide, the second plastic layer is a polyvinyl chloride, the first intermediate layer includes the metallized layer and at least one of a primer layer and an adhesive layer, and the second intermediate layer includes at least one of a primer layer and an adhesive layer.

According to a further aspect, the substrate layer is an aluminum foil, the first plastic layer is an oriented polyamide, the second plastic layer is a polyvinyl chloride, the first intermediate layer includes the metallized layer and at least one of a primer layer and an adhesive layer, and the second intermediate layer includes at least one of a primer layer and an adhesive layer.

According to yet another aspect, the substrate layer includes at least one of a cyclic olefin copolymer or a cyclic olefin polymer, the first plastic layer is a polypropylene, the second plastic layer is a polypropylene, the first intermediate layer further includes at least one of a primer layer and an adhesive layer, and the second intermediate layer includes at least one of a primer layer and an adhesive layer.

According to a still further aspect, the laminate further includes a third plastic layer connected to the first plastic layer on a side of the first plastic layer opposite the first intermediate layer. The third plastic layer may be a polyvinyl chloride.

According to additional aspects, the substrate layer may be a metal foil, a cyclic olefin copolymer, a cyclic olefin polymer. The substrate layer may also be metallized on one or both sides.

According to other aspects, the first plastic layer may be an oriented polyamide or a polyolefin, including a polyethylene or a polypropylene. The second plastic layer may be a polyvinylchloride or a polyolefin, including a polyethylene or a polypropylene.

Additional aspects of the invention relate to a laminate material including a substrate layer having first and second opposed sides, a first plastic layer located on the first side of the substrate layer, a second plastic layer located on the second side of the substrate layer, and at least one bonding layer bonding at least one of the first and second plastic layers to the substrate layer. At least one of the substrate layer, the first plastic layer, and the second plastic layer has an optical layer thereon. The optical layer may be a metallized layer, a printing ink, a pigment, a toner, and/or a lacquer layer. The laminate may also include a plurality of such optical layers, connected to one or more of the substrate layer, the first plastic layer, and the second plastic layer. More than one optical layer may be connected to the same such layer.

According to one aspect, the laminate includes a first bonding layer located between the first plastic layer and the first side of the substrate and a second bonding layer located between the second plastic layer and the second side of the substrate.

According to another aspect, the at least one bonding layer includes a primer layer and/or an adhesive layer.

According to a further aspect, the first plastic layer has the optical layer thereon, and the optical layer faces toward the substrate layer.

According to yet another aspect, the second plastic layer has the optical layer thereon, and the optical layer faces toward the substrate layer.

According to a still further aspect, the substrate has a first optical layer on the first side and a second optical layer on the second side.

According to additional aspects, the first plastic layer has a first optical layer and a second optical layer on one side thereof. The first optical layer is a printing ink, a pigment, a toner, and/or a lacquer layer, and the second optical layer is a metallized layer. In one embodiment, the second optical layer is located more proximate the substrate than the first optical layer.

Further aspects of the invention relate to a packaging article including a base part having at least one indent formed in a surface thereof, and a lid part connected to the surface of the base part. The lid part and the indent(s) of the base part define at least one cavity adapted to hold an article. At least one of the base part and the lid part is formed of a laminate material according to one or more aspects of the invention described above.

According to one aspect, the base part is formed of the laminate material, and the second plastic layer forms an inner side of the at least one indent.

According to another aspect, the packaging article is a blister pack configured for containing a medicament.

According to a further aspect, the base part includes a plurality of indents arranged in a plurality of rows, and the lid part combines with the indents to form a plurality of cavities.

Still further aspects of the invention relate to a method that incorporates a substrate layer having first and second opposed sides, a first plastic layer, and a second plastic layer. One or more optical layers are connected to one or more of the substrate layer, the first plastic layer, and the second plastic layer. Then, the first plastic layer is laminated to the first side of the substrate layer, and the second plastic layer is laminated to the second side of the substrate layer, using bonding layers between the substrate layer and the plastic layers. Each optical layer is one of a metallized layer, a printing ink, a pigment, a toner, and/or a lacquer layer.

Still other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a cross section view of one illustrative embodiment of a multi-layer laminate according to the present invention;

FIG. 1A is a magnified cross section view of one illustrative embodiment of an intermediate layer of the laminate of FIG. 1;

FIG. 1B is a magnified cross section view of another illustrative embodiment of an intermediate layer of the laminate of FIG. 1;

FIG. 1C is a magnified cross section view of a further illustrative embodiment of an intermediate layer of the laminate of FIG. 1;

FIG. 2 is a schematic cross section view illustrating a layer sequence of example embodiment A1 of a multi-layer laminate according to the present invention;

FIG. 3 is a schematic cross section view illustrating a layer sequence of example embodiment B1 of a multi-layer laminate according to the present invention;

FIG. 4 is a schematic cross section view illustrating a layer sequence of example embodiment A2 of a multi-layer laminate according to the present invention;

FIG. 5 is a schematic cross section view illustrating a layer sequence of example embodiment A3 of a multi-layer laminate according to the present invention;

FIG. 6 is a schematic cross section view illustrating a layer sequence of example embodiment A4 of a multi-layer laminate according to the present invention;

FIG. 7 is a schematic cross section view illustrating a layer sequence of example embodiment B2 of a multi-layer laminate according to the present invention;

FIG. 8 is a schematic cross section view illustrating a layer sequence of example embodiment B3 of a multi-layer laminate according to the present invention;

FIG. 9 is a schematic cross section view illustrating a layer sequence of example embodiment B4 of a multi-layer laminate according to the present invention;

FIG. 10 is a schematic cross section view illustrating a layer sequence of example embodiment B5 of a multi-layer laminate according to the present invention;

FIG. 11 is a schematic cross section view illustrating a layer sequence of example embodiment B6 of a multi-layer laminate according to the present invention;

FIG. 12 is a schematic cross section view illustrating a layer sequence of example embodiment B7 of a multi-layer laminate according to the present invention;

FIG. 13 is a schematic cross section view illustrating a layer sequence of example embodiment B8 of a multi-layer laminate according to the present invention;

FIG. 14 is a schematic cross section view illustrating a layer sequence of example embodiment B9 of a multi-layer laminate according to the present invention;

FIG. 15 is a plan view of one illustrative embodiment of a packaging material incorporating the multi-layer laminate of FIG. 1; and

FIG. 16 is a cross section view taken along lines 16-16 of FIG. 15.

It is understood that the drawing figures may not be drawn to scale, and in particular, the relative thicknesses of various layers depicted in the figures may not be representative of the actual relative thicknesses of such layers.

### DETAILED DESCRIPTION

While this invention is susceptible of embodiments in many different forms, exemplary embodiments of the invention are shown in the drawings and will herein be described in detail with the understanding that the present disclosure is to be considered as an exemplification of the principles of the invention and is not intended to limit the broad aspect of the invention to the embodiments illustrated.

In one illustrative embodiment, a multi-layer laminate includes a substrate layer, first and second plastic layers located on opposed sides of the substrate layer, and at least one intermediate layer located between the substrate layer and the first plastic layer and/or between the substrate layer and the second plastic layer.

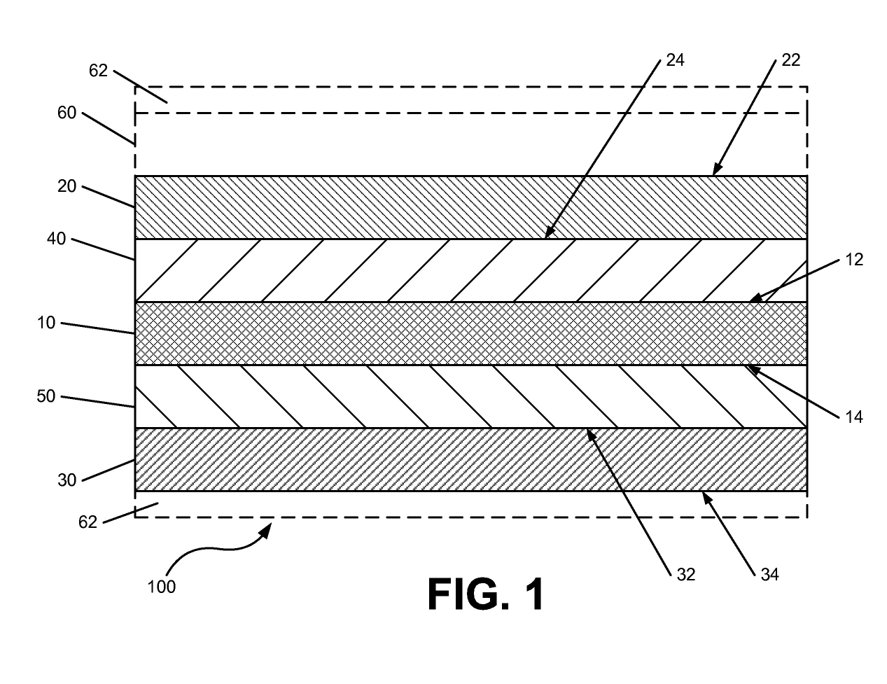

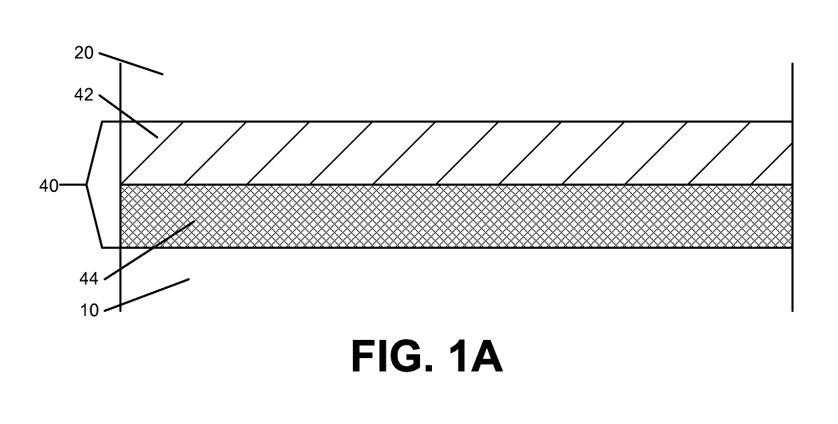

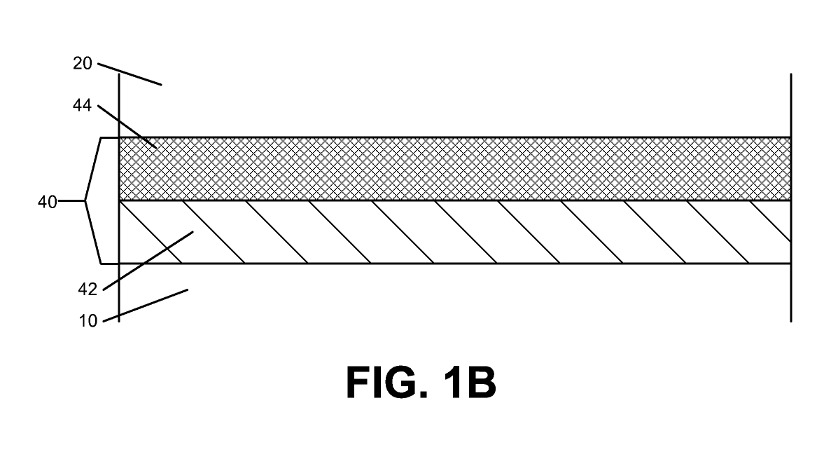

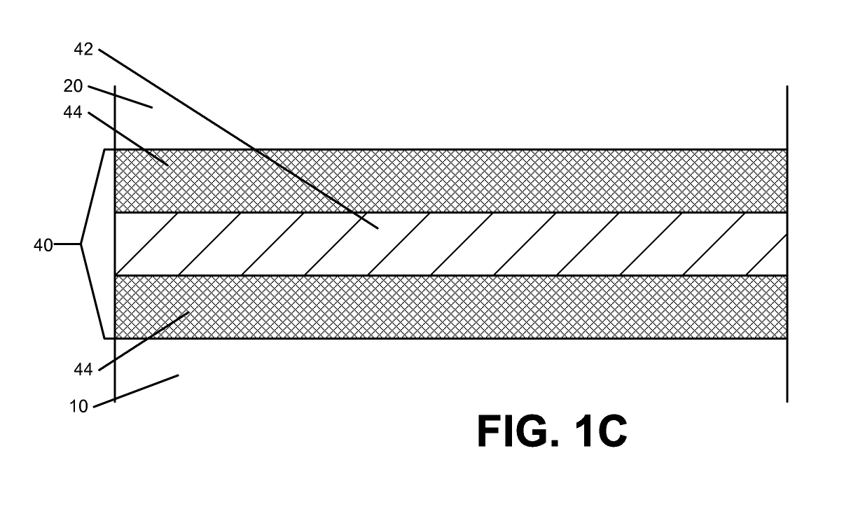

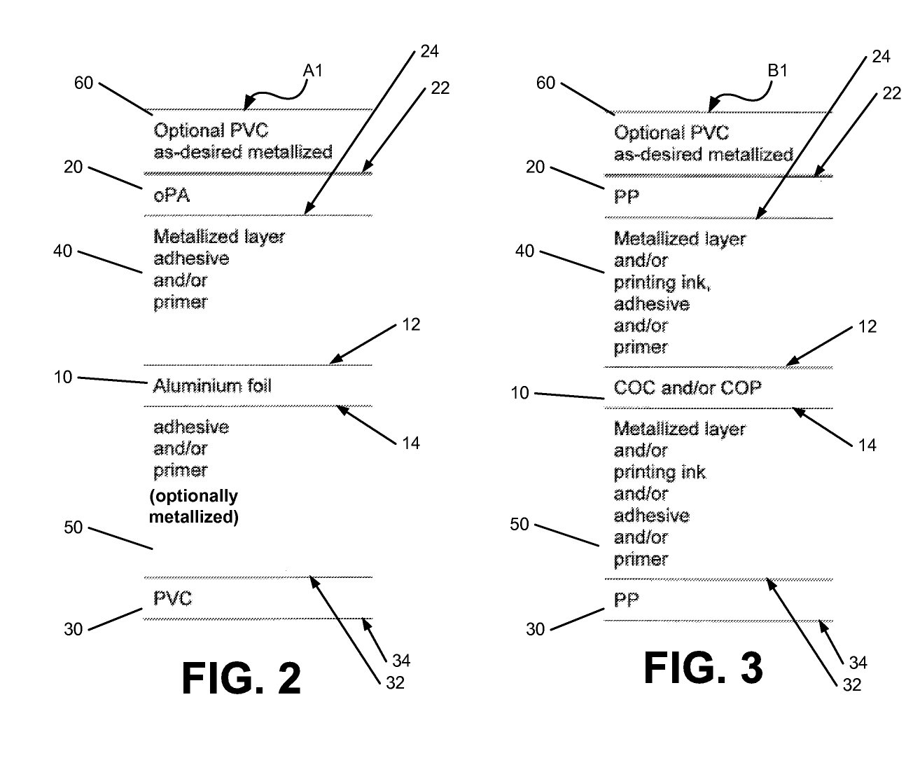

FIG. 1 illustrates one example embodiment of a multi-layer laminate 100 that includes a substrate layer 10 having first and second opposed surfaces 12, 14, a first plastic layer 20 having first and second opposed sides 22, 24 and located on the first side 12 of the substrate 10, a second plastic layer 30 having first and second opposed sides 32, 34 and located on the second side 14 of the substrate 10, and at least one intermediate layer located between the first side 12 of the substrate 10 and the first plastic layer 20 and/or between the second side 14 of the substrate 10 and the second plastic layer 30. In the embodiment illustrated in FIG. 1, the laminate 100 includes a first intermediate layer 40 positioned between the substrate 10 and the first plastic layer 20 and a second intermediate layer 50 positioned between the substrate 10 and the second plastic layer 30. The first intermediate layer 40 is connected to the first surface 12 of the substrate 10 and the second surface 24 of the first plastic layer 20, and the second intermediate layer 50 is connected to the second surface 14 of the substrate and the first surface 32 of the second plastic layer 30. The laminate 100 may further include an optional third plastic layer 60, which may optionally be connected to the first surface 22 of the first plastic layer 20. In some embodiments, either the first intermediate layer 40 or the second intermediate layer 50 may be optional. For example, in one embodiment, the laminate 100 includes the first intermediate layer 40 between the substrate 10 and the first plastic layer 20, and the second intermediate layer 50 between the substrate 10 and the second plastic layer 30 may be optional. Additionally, in another embodiment, one or more additional layers may be present, in addition to the layers shown in FIG. 1. As described below and shown in the embodiments of FIGS. 2-14, the intermediate layer(s) 40, 50 can be formed on one or more of the substrate 10, the first plastic layer 20, and/or second plastic layer 30.

The layers of the laminate described above and shown in FIG. 1 may be made from one or more various films, foils, adhesives, and other materials. Examples of films and foils that may be employed for the production of laminates contain or comprise plastics, including polyolefins, such as polyethylene (PE) or poly-propylene (PP), polyamides (PA), COC (cyclic olefinic copolymers) or COP (cyclic olefinic polymers), or polyvinylchloride (PVC), or copolymers of the polymers mentioned herein, as well as other polymers, copolymers, and further suitable materials. The films or foils may be employed, for example, in the non-stretched, mono-axial or biaxial stretched or oriented state. One or more layers of the laminate may also contain or comprise metal foils, for example, aluminum, iron, steel, or other metals, including any alloys or composites of such metals.

In one embodiment, the substrate 10 is wholly or partially formed from an aluminum foil or other metal foil, and in another embodiment, the substrate is wholly or partially formed from a COC (cyclic olefin copolymer) or a COP (cyclic olefin polymer).

Examples of substrates in the form of metal foils include metals described above, such as aluminum, iron, steel etc. In one embodiment, an aluminum foil substrate 10 may be a foil of high purity aluminum (99.9% and higher), or of an aluminum alloy, such as an alloy in the series Al—Mn, Al—Fe—Mn, Al—Fe—Si, Al—Fe—Si—Mn, etc. In one embodiment, a metal foil may be used having a thickness of 20 to 100 μm, but other thicknesses can be used. In one such embodiment, an aluminum foil having a thickness of 40 to 50 μm may be used, such as a foil having a thickness of 45 μm.

In another embodiment, the substrate 10 may be formed of COC or COP with a thickness of from 30 to 300 μm, and in another embodiment, the thickness is from 190 to 240 μm. In one example embodiment, the laminate 100 has a COC substrate 10, comprised of olefin type polymers with an amorphous structure, such as copolymers of ethylene and 2-norbonene or tetracyclododecen. COC and COP are highly transparent and very brittle materials with a good barrier action against the passage of water vapour, and provide suitable materials for use in the laminate structure. COC and COP may also be co-extruded along with other materials such as polyethylene or polypropylene, forming a multi-layer substrate material.

The intermediate layer(s) 40, 50, if present, may each constitute a single layer or multiple layers, and may include at least one of the following: a metallized layer, a printing ink, a pigment, a toner, a lacquer layer, a primer layer, and/or an adhesive layer, all of which are described in greater detail below. In one embodiment, the intermediate layer(s) 40, 50 include at least one primer layer and/or at least one adhesive layer between the substrate 10 and the first plastic layer 20, and at least one primer layer and/or at least one adhesive layer between the substrate 10 and the second plastic layer 30. In another embodiment, one or both of the intermediate layers 40, 50 include at least one bonding layer, such as a primer layer or an adhesive layer, in combination with at least one optical layer, such as a metallized layer, a printing ink, a pigment, a toner, and/or a lacquer layer. In this embodiment, the optical layer(s) impart at least one optical property to the laminate, such as opacity, reflection, refraction, colouring, or other such optical properties, and the bonding layer(s) function at least in part to bond the other layers of the laminate together.

FIG. 1A illustrates one example embodiment of an intermediate layer 40 that includes an optical layer 42 and a bonding layer 44 positioned between the optical layer 42 and the substrate 10. In this example, the optical layer 42 may be printed, deposited, etc. on the first plastic layer 20, and the resultant layer may be bonded to the substrate 10 by the bonding layer 44. It is understood that the optical layer 42 may be on the opposite side of the first plastic layer 20. FIG. 1B illustrates one example embodiment of an intermediate layer 40 that includes an optical layer 42 and a bonding layer 44 positioned between the optical layer 42 and the first plastic layer 20. In this example, the optical layer 42 may be printed, deposited, etc. on the substrate 10, and the resultant layer may be bonded to the first plastic layer 20 by the bonding layer 44. FIG. 1C illustrates one example embodiment of an intermediate layer 40 that includes an optical layer 42, a first bonding layer 44 positioned between the optical layer 42 and the first plastic layer 20, and a second bonding layer 44 positioned between the optical layer 42 and the substrate 10. It is understood that the features of the intermediate layer 40 in FIGS. 1A-1C may be additionally or alternately included in the intermediate layer 50 located between the substrate 10 and the second plastic layer 30.

The primer (which may be an undercoat lacquer) may be provided between the surfaces of the layers (10, 20, 30, etc.) that are to be laminated to each other. Instead of, or along with the primer, an adhesive or other bonding agent may be provided between the layers (10, 20, 30, etc.) in one embodiment. Examples of suitable bonding agents or adhesives include solvent-based, water-based, or water-soluble bonding agents or adhesives, and may be single or multi-component bonding agents or adhesives. Additional examples of suitable adhesives include so-called hot-melts, ethyl-vinyl-alcohols, paraffins, urethane, or epoxy based acrylic laminating adhesives. In one embodiment, the weight per unit area of primers and/or adhesives may be 0.8 to 6.0 g/m².

Examples of suitable primers that may be used in embodiments of the laminate include acrylic lacquers, PVC-copolymer lacquers, cellulose nitrate, polyester resin, polyester-melamine resin, and other known primers, and the primer may additionally contain a fraction of filler material such as silica or organic particles. It is understood that the examples of primers and adhesives provided herein are not exhaustive or exclusive.

The first and second plastic layers 20, 30 may be formed of one or more different plastics or other polymers, including any of the polymers and copolymers described herein. Additionally, the first and second plastic layers 20, 30 may be monofilms or multi-layer films of the same plastic, in some embodiments.

In example embodiments, the first plastic layer 20 may be a layer of a polyamide, such as an oriented polyamide (oPA), a polyester (PET), or a polyolefin, such as a polyethylene or a polypropylene (PP). Additional polymers may be used for the first plastic layer 20, including those described above and other known polymers.

In example embodiments, the second plastic layer 30 may be a layer of a polyvinylchloride (PVC) or a polyolefin, such as a polyethylene or a polypropylene (PP). The second plastic layer 30 may be a film of the mentioned plastics, and the films may be non-stretched or mono-axially or biaxially stretched. Additional polymers may be used for the second plastic layer 30, including those described above and other known polymers.

In one embodiment, films and foils employed for the substrate 10 and/or the first and second plastic layers 20, 30 may have thicknesses from 12 to 50 μm, and in another embodiment, the thicknesses may be from 25 to 40 μm. For example, in one embodiment, polyolefin films or foils are used, having thicknesses of 12 to 50 μm, or in another embodiment, from 25 to 40 μm.

Foils and films of PVC can provide many useful properties when incorporated into one or more layers of the laminate structure, such as reinforcing and shape-stability of the component in question. In one embodiment, a film or foil of PVC may be used in the first or second plastic layer 20, 30, having a thickness of 12-100 μm. In another embodiment, a PVC film or foil may have a thickness of 40-80 μm, and in a further embodiment, the thickness may be 60 μm. As described below, PVC may also be used in an optional third plastic layer 60.

As described elsewhere herein, the laminate 100 may also include metallized layers in some embodiments. For example, in one embodiment, one or both of the intermediate layers 40, 50 may include a metallized layer, and such metallized layers may be formed by metallizing one or more of the substrate 10, the first plastic layer 20, and/or the second plastic layer 30. In another embodiment, layer may be metallized, including the optional third plastic layer 60 described below. The metallized layers may be employed in various amounts ranging from 0.1 to 1.0 g/m² in one embodiment, and amounts of 0.08 to 0.15 g/m² are useful and 0.1 g/m² is advantageous.

The metallized layers may be deposited using any known technique, including chemical or physical deposition processes, for example, by sputtering or precipitation from the gas phase in vacuum, such as a CVD (chemical vapour deposition) or PVD (physical vapour deposition).

In some embodiments, the metallized layer contains or is comprised of aluminum (including aluminum alloys). In one embodiment, the aluminum is used in a very pure form, i.e. having a purity of 99.9% or greater. The metallized aluminum layer may be deposited, in various example embodiments, in amounts of from 0.01 to 1.0 g/m², or from 0.09 to 0.2 g/m². The metallized layer can be used to form a reflecting layer, which essentially reflects light, including visible light, completely and allows little to no residual light to pass through the laminate. Other types of reflecting materials can be used as a reflective optical layer, in other embodiments.

In another embodiment, one or both intermediate layers 40, 50 may additionally or alternately include a printing ink. Printing inks for printing on the mentioned plastic and metal surfaces may be, for example, suitable water-based or solvent based printing inks or pigments. The printing inks may be applied in the form of simple or multiple printing, by relief printing, intaglio printing, offset printing or flexo-printing in printing machines, or using other techniques known in the art. Electrophotographic printing methods may also be employed, including, for example, methods using liquid and/or dry toners, such as UV or electron beam curing toners. The thickness of print may be transparent, translucent or opaque. The printing inks, pigments, toners and/or lacquers may be deposited over the whole or part of the surface and may have one or different colours. In the case of complete or partial coverage, the printing may involve an abstract random or repetitive image or, in the case of partial deposition, a printed image, script, symbol or logo which may contain one or more colours. In order to achieve a particular intensity, transparency or opaqueness, the characteristics of the printing ink, pigment, toner and/or lacquer may be controlled or influenced by the colour, filler material and/or thickness of ink, pigment, toner and/or lacquer deposited.

The laminate may include one or more additional plastic layers other than the first and second plastic layers 20, 30, such as a third plastic layer 60, which is indicated as optional in FIG. 1. As described above with respect to the first and second plastic layers 20, 30, the third plastic layer 60 may be a film or foil, including monofilms or multi-layer films of the same plastic, in some embodiments. Any additional plastic layers, such as the third plastic layer 60, may be bonded to the first or second plastic layers 20, 30, and/or to each other, using adhesives and/or primers, as described above. In the embodiment illustrated in FIG. 1, the third plastic layer is optionally connected to the first surface 22 of the first plastic layer 20.

In one example embodiment, the third plastic layer 60 may be a PVC film, such as in the embodiments A1 and B1 in FIGS. 2-3. The PVC film may have a thickness of 12 to 100 μm in one embodiment, and may have a thickness of 40 to 80 μm in another embodiment, and 60 μm in a further embodiment. The PVC film may further be metallized on at least one side.

As further illustrated in FIG. 1, in one embodiment, one or both outer sides of the laminate 100 may optionally have a sealing layer 62, such as a sealing film, a sealing lacquer, or other known sealing layers. The sealing layer 62 may be deposited over the whole surface or over only part of the surface, and may further be arranged taking into consideration the contours to be sealed layer. In the embodiment shown in FIG. 1, if one or more sealing layers 62 are included, the sealing layer(s) 62 may be arranged on the first side 22 of the first layer 20 and/or the second side 34 of the second layer 30. Alternately, if one or more additional plastic layers (such as the third plastic layer 60) are connected to the first and/or second plastic layers 20, 30, the sealing layer(s) 62 may be arranged on the additional plastic layer(s). In other embodiments, still further types of additional layers may be present, in addition to those described herein.

FIGS. 2-14 illustrate several general examples of layer sequences for various different embodiments of laminate structures according to the invention. The layer sequences are designated as embodiments A1, B1, etc., and from top downwards, each sequence exhibits, schematically, the individual layers which are present and which may optionally, additionally, or alternatively be present in variations of each example embodiment. Various examples of laminates and the layer sequences contained therein are described in the layer sequences A1 to B9, and it is understood that each general embodiment of sequences A1 to B9 may contains several variations, each of which is recognized as a separate specific embodiment. As such, the description below and/or the drawing figures indicate that the components in question may additionally or alternatively be included in different embodiments. Additionally, the reference numerals used above in the specification and in connection with FIGS. 1-1C are used consistently in FIGS. 2-14 to refer to similar components of the depicted laminate embodiments. It is understood that some of the reference numerals in FIGS. 2-14 may refer to structures described previously in the specification, and may not be described in the specification with respect to each individual figure.

In some embodiments, such as embodiments A1 and B1 in FIGS. 2 and 3, the laminate may optionally include a third plastic layer 60 arranged on the first side 22 of the first plastic layer 20. The third plastic layer 60 may be metallized on one or both sides and may be joined to the first plastic layer 20 via a primer and/or adhesive (not shown). In other embodiments, the third plastic layer 60 may not be included, or one or more additional layers may be included in a different sequence, such as by connecting the third plastic layer 60 to the second plastic layer 30. In the embodiments A1 and B1 shown in FIGS. 2-3, the optional third plastic layer 60 may be formed of PVC, which may optionally be metallized on one or both sides as desired. In other embodiments, if a third plastic layer 60 is included, that layer may be formed of a different material. It is understood that any of the embodiments A1-B9 in FIGS. 2-14 may have one or more additional plastic layers connected thereto, and/or may also have one or more sealing layers 90 as also shown in FIG. 1.

The layer sequence embodiment A1, shown in FIG. 2, includes an aluminum foil as a substrate 10, a first plastic layer 20 of oPA, and a second plastic layer 30 of PVC. It is understood that the aluminum foil may include aluminum alloys, as described above. The first intermediate layer 40 includes an optical layer in the form of a metallizing layer arranged between the substrate 10 and the first plastic layer 20, as well as at least one bonding layer in the form of at least one adhesive and/or primer layer. In this and other embodiments, the adhesive and/or primer of the first intermediate layer 40 may be arranged on one or both sides of the metallizing layer or other optical layer. The second intermediate layer 50 in this embodiment is optional, and if present, includes an adhesive and/or primer layer arranged between the substrate 10 and the second plastic layer 30.

The layer sequence embodiment B1, shown in FIG. 3, includes a COC and/or COP film as a substrate 10, a first plastic layer 20 of PP, and a second plastic layer 30 of PP. The first intermediate layer 40 includes at least one optical layer in the form of a metallizing layer and/or a printing ink arranged between the substrate 10 and the first plastic layer 20, as well as at least one bonding layer in the form of at least one adhesive and/or primer layer. In one such embodiment, the first intermediate layer 40 includes both a metallizing layer and a printing ink that complement each other, and the metallizing covers the whole surface. In this embodiment, the printing ink may lie nearer the first plastic layer 20, enabling the printing ink to be visible from the exterior. The second intermediate layer 50 includes at least one optical layer in the form of a metallizing layer and/or a printing ink arranged between the substrate 10 and the second plastic layer 30, as well as additionally or alternately at least one bonding layer in the form of an adhesive and/or primer layer. While not described in detail herein for the sake of brevity, it is understood that all layers described as “printing ink” in embodiments A1-B9 may include one or more pigments, one or more toners, and/or a lacquer layer, either in addition to or in place of printing ink.

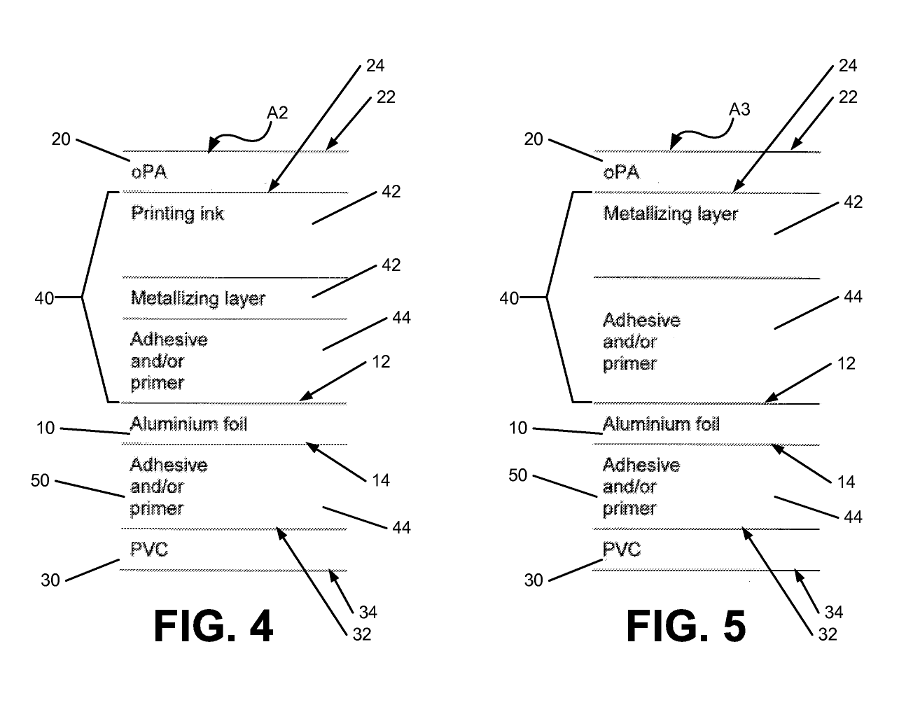

The layer sequence embodiments A2 to A4, shown in FIGS. 4-6, include an aluminum foil as the substrate 10, a first plastic layer 20 of oPA and a second plastic layer 30 of PVC. In example embodiment A2 (FIG. 4), the oPA film 20 is covered on one side with optical layers 42 containing a printing ink and a metallizing layer, which may be produced by printing on one side of the oPA film 20 and then metallizing the film 20. In this embodiment, the printing ink and metallizing layers 42 are arranged on the inside on the oPA film 20, i.e. directed toward the substrate 10. In another embodiment, the printing ink may also be arranged on the outside of the first plastic layer 20, but may be less protected and more susceptible to damage by mechanical means from the outside. Bonding layers 44 in the form of an adhesive and/or primer layer may be arranged between the substrate 10 and the first and second plastic layers 20, 30. In manufacturing the laminate of embodiment A2, the oPA film 20 is printed on with printing ink and then metallized. Then, the substrate 10, the first plastic layer 20 and the second plastic layer 30 are bonded together, such as by means of the adhesive and/or primer layer(s) 44.

Example embodiment A3 (FIG. 5) has a structure similar to that of example embodiment A2, but without the presence of the printing ink on the first plastic layer 20. In manufacturing the laminate of embodiment A3, the oPA film is metallized on one side, such that the metallized layer 42 is arranged directed inwards on the oPA film 20, i.e. toward the substrate 10. The metallized layer 42 may also be arranged outside in another embodiment, but may be less protected and more susceptible to damage from the outside, such as by mechanical or other means. After the oPA film 20 is metallized, the substrate 10, the first plastic layer 20, and the second plastic layer 30 are bonded together, such as by means of the adhesive and/or primer layer(s) 44.

Example embodiment A4 (FIG. 6) has a structure similar to that of example embodiment A3, except that the metallizing layer 42 and the bonding layer 44 of the first intermediate layer 40 are transposed from the arrangement in embodiment A3. In manufacturing the laminate of embodiment A4, the aluminum foil substrate 10 is metallized on one side 12, such that the metallized layer 44 is directed against the first plastic layer 20, (the oPA film in this embodiment). After the aluminum foil 10 is metallized on one side, then the substrate 10, the first plastic layer 20 and the second plastic layer 30 are bonded together, such as by means of the adhesive and/or primer layer(s) 44.

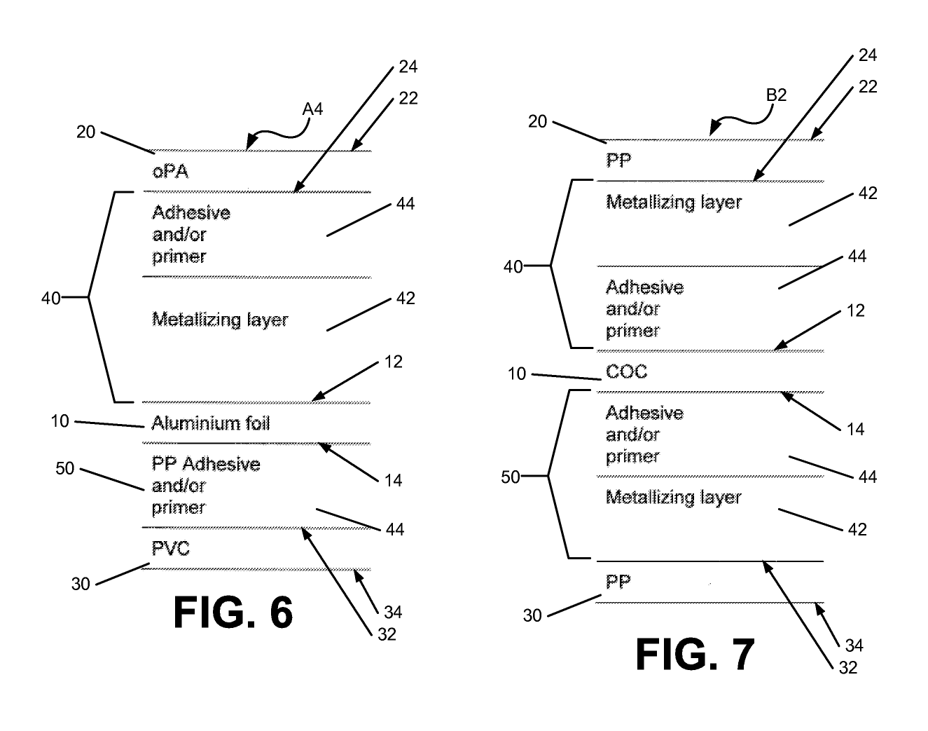

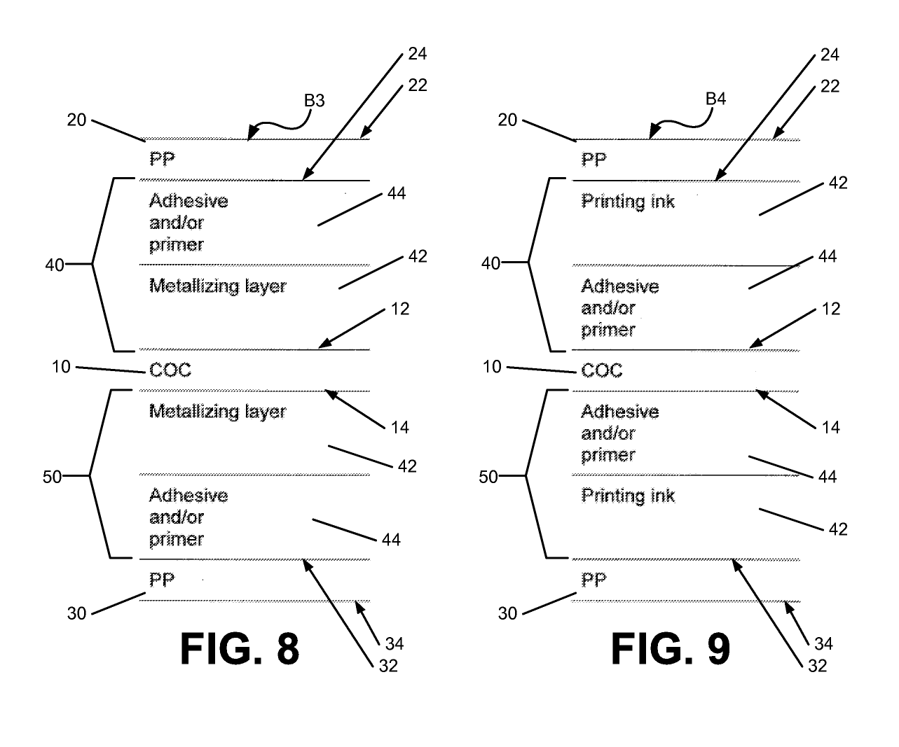

The layer sequence embodiments B2 to B4, shown in FIGS. 7-9, include a COC film as substrate 10, a first plastic layer 20 of PP, and a second plastic layer 30 of PP. The layer sequence embodiment B2 (FIG. 7) can be manufactured by metallizing a PP film on one side, laminating the metallized PP film on one side 12 of the substrate 10 to form the first plastic layer 20 with a metallizing layer 42 thereon, and laminating the metallized PP film on the other side 14 of the substrate 10 to form the second plastic layer 30 with a metallizing layer 42 thereon. Adhesive and/or primer layers 44 may be used in laminating the plastic layers 20, 30 to the substrate 10. The layer sequence embodiment B3 (FIG. 8) can be manufactured by metallizing a COC film on both sides 12, 14 to form a substrate 10 of COC film with metallizing layers 42 on both sides 12, 14, and then laminating a PP film on opposite sides of the COC substrate 10 to form the first plastic layer 20 and the second plastic layer 30. Adhesive and/or primer layers 44 may be used in laminating the plastic layers 20, 30 to the substrate 10. The layer sequence embodiment B4 (FIG. 9) can be manufactured by printing a PP film on one side, laminating the printed PP film on one side 12 of the substrate 10 to form the first plastic layer 20 with a printed layer 42 thereon, and laminating the printed PP film on the other side 14 of the substrate 10 to form the second plastic layer 30 with a printed layer 42 thereon. Adhesive and/or primer layers 44 may be used in laminating the plastic layers 20, 30 to the substrate 10. In this embodiment, the printing is arranged on the inner sides of the first and second layers 20, 30, i.e. the sides facing the substrate 10, in order to avoid any damage due to mechanical influences such as scratching, wear, etc.

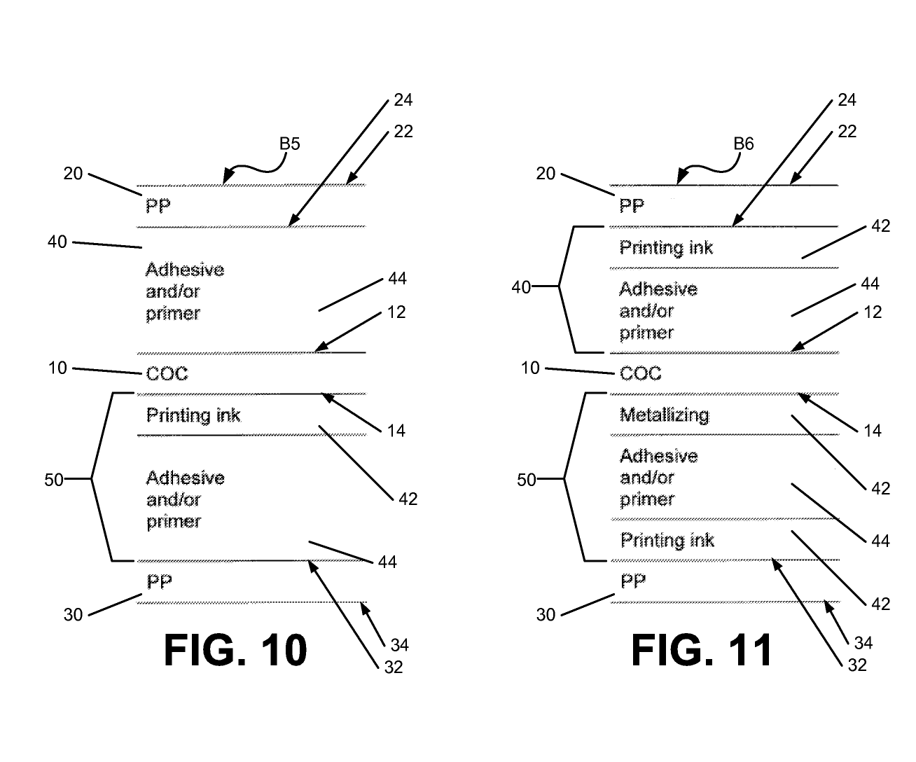

The layer sequence embodiments B5 to B9, shown in FIGS. 10-14, include a COC film as a substrate 10, a first plastic layer 20 of PP and a second plastic layer 30 of PP. In these embodiments, one or more bonding layers 44 including adhesives and/or primers can be used for bonding between the layers, as similarly described above. Additionally, in these embodiments, optical layers 42 of printing ink and/or metallizing are arranged between the first plastic layer 20 and the substrate 10 and/or between the second plastic layer 30 and the substrate 10, as shown in FIGS. 10-14.

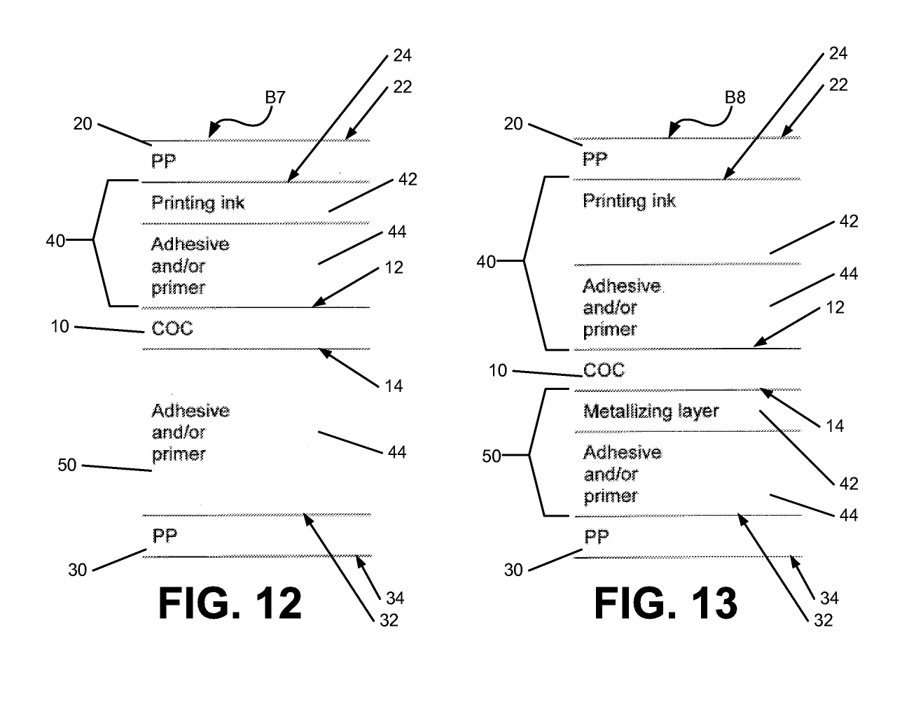

In the layer sequence embodiment B5 (FIG. 10), the COC substrate 10 is printed on one side 14 as described above, and layers of PP are laminated on both sides 12, 14 of the substrate 10 using bonding layers 44 to form the first and second plastic layers 20, 30. In this embodiment, the printing ink 42 on the substrate 10 faces toward the second plastic layer 30. In the layer sequence embodiment B6 (FIG. 11), the PP film forming the first and second plastic layers 20, 30 is printed on one side, and a COC film forming the substrate 10 is metallized on one side 14. The printed PP film is then laminated on both sides 12, 14 of the COC substrate 10 using bonding layers 44, to form the first and second plastic layers 20, 30, each having an optical (printing ink) layer 42 thereon facing toward the substrate 10. The substrate 10 is also connected to the optical (metallizing) layer 42 facing toward the second plastic layer 30. In the layer sequence embodiment B7 (FIG. 12), a PP film is printed on and laminated to one side 12 the COC substrate 10, using a bonding layer 44, to form the first plastic layer 20 having a printing ink 42 thereon. Another non-printed PP film is laminated to the other side 14 of the substrate 10, using a bonding layer 44, to form the second plastic layer 30.

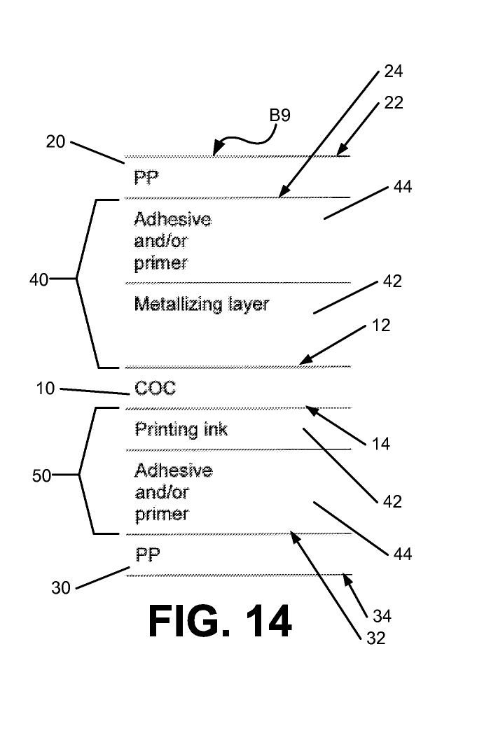

In the layer sequence embodiment B8 (FIG. 13), a substrate 10 in the form of a COC film is metallized on one side 14, and a PP film is printed on one side. The printed PP film is then laminated to the non-metallized side 12 of the COC substrate 10, using a bonding layer 44, to form the first plastic layer 20, so that the printing ink 42 faces the substrate 10. A non-printed PP film is laminated on the metallized side 14 of the substrate 10, using a bonding layer 44, to form the second plastic layer 30. In the layer sequence embodiment B9 (FIG. 14), a substrate 10 in the form of a COC film is metallized on one side 12 and printed on the opposite side 14. The substrate 10 is then laminated on both sides 12, 14 by a PP film to form the first plastic layer 20 on the metallized side 12 and the second plastic layer 30 on the printed side 14.

It is understood that the embodiments described above, including the laminate 100 in FIGS. 1-1C and the embodiments A1-B9 in FIGS. 2-14 may contain different features. In other embodiments, any of the features or variations of such embodiments described above can be incorporated into any other such embodiment, and all combinations of such embodiments are envisioned as aspects of the present invention.

Various embodiments of the laminates or layer materials according to the invention are flexible and capable of bending, such that the layers are capable of being rolled up or coiled. In one embodiment, these flexible laminates are capable of being manufactured as rolled or coiled product. However, in other embodiments, the laminates can be manufactured in another manner, such as in sheet form.

Methods of manufacturing various embodiments of laminate materials are also described herein above, including printing and/or metallizing various films or layers and laminating such films and layers together in specific orientations to form laminate products. Laminating multiple layers, as described herein, may be accomplished, in some embodiments, by co-extrusion of similar techniques. Such methods are also envisioned as aspects of the present invention.

As described above, the laminates described herein can provide beneficial and advantageous performance when used as packaging material. As such, the manufactured laminate may be divided into lengths for further use as packaging material. Before dividing into lengths, the laminate may also be deep drawn or stretch formed, for example, and indents or depressions may be formed in the laminate. If desired, the indents or depressions may be arranged uniformly or in groups over the area of the laminate. In one example, the depressions may exhibit a draw ratio from 1.5:1 and greater. A laminate prepared in such a manner can then be divided into lengths, to form base parts or support structures of push-through or blister packs or the like, each having a plurality of indents. In one embodiment, the laminate is arranged so the second plastic layer 30 forms the inner side of the recesses and faces the contents of the packaging. If the base parts formed by the laminate are filled with articles such as pills, tablets, dragees, ampoules, etc., then the base part may subsequently be lidded. Such lidding can be accomplished, for example, by adhesively fixing or sealing a flanged lid foil onto the base part. Such lid materials may be made from a laminate as described herein, or another lid material may be employed. Examples of other such lid materials are coated aluminum foil or aluminum foil laminated with plastics such as polyolefin (e.g. polyethylene or polypropylene), laminated aluminum foils, metallized plastics such as metallized polyethylene-terephthalate (PET), metallized polyamide, and other lid materials known in the art.

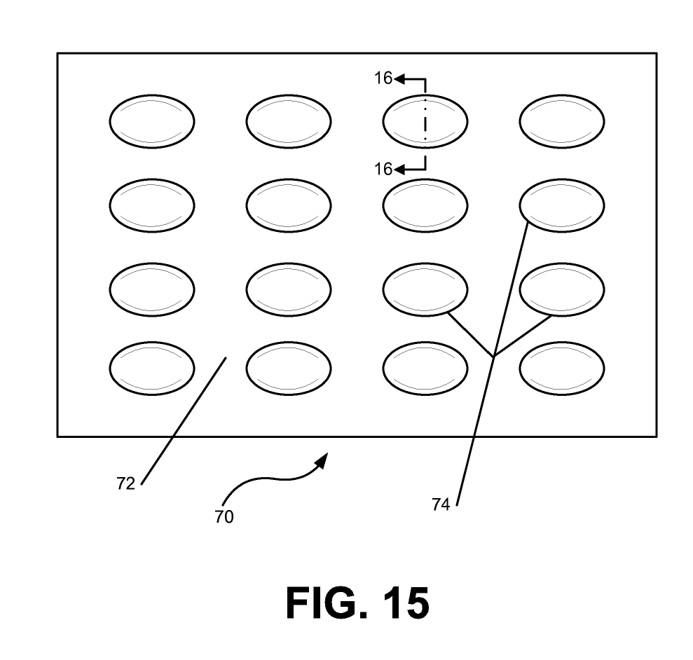

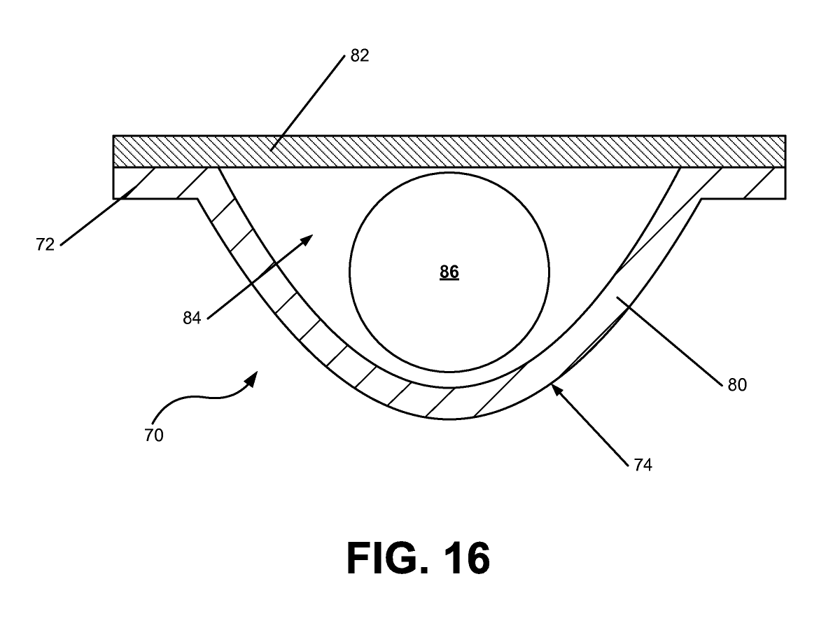

FIGS. 15-16 illustrate one example embodiment of a packaging material 70 as described above. As shown in FIG. 15, a base part or support structure 72 is provided, including a plurality of indents or recesses 74 arranged in symmetrical rows. As shown in FIG. 16, a lid part 82 can be connected to the base part 72, such that the indents 74 of the base part 72 combine with the lid part 82 to define a plurality of cavities 84. Each cavity 84 is configured to hold an article 86 therein, such as a medicament product in a blister pack, as described above. Either or both of the base part 72 and the lid part 82 may be formed using a laminate as described herein, including any of the embodiments and variations described above.

Embodiments of the laminates or layer materials described herein can provide benefits and advantages over prior laminate materials. For example, the laminate materials can be used to provide packaging material with a coloured or reflective appearance, among other desired optical qualities. Depending on the position of the metallizing layer or the layers coloured by the inks, pigment, toner, or lacquer, the appearance to the human eye of a packaging produced with the laminates or layer materials will vary. Thus, packaging with a variety of different appearances can be designed by changing the content, structure, and/or layer sequence of the laminate material as described herein. For example, the metallizing layers are reflective and give basically a mirror-like or metallic appearance, which can vary from dull to glossy. The colours produced by the printing inks may give a dull to shiny impression of the surface of the packaging material. By combining metallized laminates and laminates having coloured surfaces, multifaceted packaging forms can be produced. Still other benefits and advantages are readily recognizable to those skilled in the art.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Further, “providing” an article or apparatus, as used herein, refers broadly to making the article available or accessible for future actions to be performed on the article, and does not connote that the party providing the article has manufactured, produced, or supplied the article or that the party providing the article has ownership or control of the article. Accordingly, while specific embodiments have been illustrated and described, numerous modifications come to mind without significantly departing from the spirit of the invention and the scope of protection is only limited by the scope of the accompanying Claims.

What is claimed is:

1. A laminate comprising:
a substrate layer having first and second opposed sides;
a first plastic layer located on the first side of the substrate layer;
a second plastic layer located on the second side of the substrate layer; and
an intermediate layer located between the substrate layer and one of the first plastic layer and the second plastic layer, the intermediate layer comprising at least one layer selected from a group consisting of: a metallized layer, a printing ink, a pigment, a toner, and a lacquer layer.

2. The laminate of claim 1, wherein the intermediate layer further comprises at least one of a layer of primer and a layer of adhesive.

3. The laminate of claim 1, wherein the intermediate layer is located between the first side of the substrate layer and the first plastic layer, and the laminate further comprises a second intermediate layer located between the second side of the substrate layer and the second plastic layer, the second intermediate layer comprising at least one layer selected from a second group consisting of: a metallized layer, a printing ink, a pigment, a toner, a lacquer layer, a primer layer, and an adhesive layer.

4. The laminate of claim 3, wherein the substrate layer comprises an aluminum foil, the first plastic layer comprises an oriented polyamide, the second plastic layer comprises a polyvinyl chloride, the first intermediate layer comprises the metallized layer and at least one of a primer layer and an adhesive layer, and the second intermediate layer comprises at least one of the primer layer and the adhesive layer.

5. The laminate of claim 3, wherein the substrate layer comprises an aluminum foil, the first plastic layer comprises an oriented polyamide, the second plastic layer comprises a polyvinyl chloride, the first intermediate layer comprises the metallized layer and at least one of a primer layer and an adhesive layer, and the second intermediate layer comprises at least one of the primer layer and the adhesive layer.

6. The laminate of claim 3, wherein the substrate layer comprises at least one of a cyclic olefin copolymer or a cyclic olefin polymer, the first plastic layer comprises a polypropylene, the second plastic layer comprises a polypropylene, the first intermediate layer further comprises at least one of a primer layer and an adhesive layer, and the second intermediate layer comprises at least one of the primer layer and the adhesive layer.

7. The laminate of claim 1, wherein the substrate layer comprises a metal foil.

8. The laminate of claim 1, wherein the substrate layer comprises at least one of a cyclic olefin copolymer and a cyclic olefin polymer.

9. The laminate of claim 8, wherein the substrate layer is metallized on at least one of the first side and the second side.

10. The laminate of claim 1, wherein the first plastic layer comprises an oriented polyamide or a polyolefin.

11. The laminate of claim 10, wherein the first plastic layer comprises a polyethylene or a polypropylene.

12. The laminate of claim 1, wherein the second plastic layer comprises a polyvinylchloride or a polyolefin.

13. The laminate of claim 12, wherein the second plastic layer comprises a polyethylene or a polypropylene.

14. The laminate of claim 1, further comprising a third plastic layer connected to the first plastic layer on a side of the first plastic layer opposite the substrate layer.

15. A laminate comprising:
a substrate layer having first and second opposed sides;
a first plastic layer located on the first side of the substrate layer;
a second plastic layer located on the second side of the substrate layer; and
at least one bonding layer bonding at least one of the first and second plastic layers to the substrate layer,
wherein one of the substrate layer, the first plastic layer, and the second plastic layer has an optical layer thereon, the optical layer being selected from a group consisting of: a metallized layer, a printing ink, a pigment, a toner, and a lacquer layer.

16. The laminate of claim 15, further comprising a second optical layer connected to one of the substrate layer, the first plastic layer, and the second plastic layer, the second optical layer being selected from a group consisting of: a metallized layer, a printing ink, a pigment, a toner, and a lacquer layer.

17. The laminate of claim 15, wherein the at least one bonding layer comprises a first bonding layer located between the first plastic layer and the first side of the substrate and a second bonding layer located between the second plastic layer and the second side of the substrate.

18. The laminate of claim 15, wherein the at least one bonding layer comprises at least one of a primer layer and an adhesive layer.

19. The laminate of claim 15, wherein the first plastic layer has the optical layer thereon, the optical layer facing toward the substrate layer.

20. The laminate of claim 15, wherein the second plastic layer has the optical layer thereon, the optical layer facing toward the substrate layer.

21. The laminate of claim 15, wherein the substrate has the optical layer on the first side and a second optical layer on the second side.

22. The laminate of claim 15, wherein the first plastic layer has the optical layer and a second optical layer on a side thereof, wherein the optical layer is selected from a group consisting of: the printing ink, the pigment, the toner, and the lacquer layer, and the second optical layer is a metallized layer.

23. The laminate of claim 22, wherein the second optical layer is located more proximate the substrate than the optical layer.

24. A packaging article comprising:
a base part having at least one indent formed in a surface thereof;
a lid part connected to the surface of the base part, wherein the lid part and the at least one indent of the base part define at least one cavity adapted to hold an article,
wherein at least one of the base part and the lid part is formed of a laminate material comprising:
a substrate layer having first and second opposed sides;
a first plastic layer located on the first side of the substrate layer;
a second plastic layer located on the second side of the substrate layer; and
an intermediate layer located between the substrate layer and one of the first plastic layer and the second plastic layer, the intermediate layer comprising at least one layer selected from a group consisting of: a metallized layer, a printing ink, a pigment, a toner, and a lacquer layer.

25. The packaging article of claim 24, wherein the base part is formed of the laminate material, and the second plastic layer forms an inner side of the at least one indent.

26. The packaging article of claim 24, wherein the packaging article is a blister pack configured for containing a medicament.

27. The packaging article of claim 24, wherein the base part comprises a plurality of indents arranged in a plurality of rows, and the lid part combines with the indents to form a plurality of cavities.

28. The packaging article of claim 24, wherein the intermediate layer is located between the first side of the substrate layer and the first plastic layer, and the laminate further comprises a second intermediate layer located between the second side of the substrate layer and the second plastic layer, the second intermediate layer comprising at least one layer selected from a second group consisting of: a metallized layer, a printing ink, a pigment, a toner, a lacquer layer, a primer layer, and an adhesive layer.

29. A method comprising:
providing a substrate layer having first and second opposed sides, a first plastic layer, and a second plastic layer;
connecting an optical layer to one of the substrate layer, the first plastic layer, and the second plastic layer;
laminating the first plastic layer to the first side of the substrate layer, using a bonding layer between the substrate layer and the first plastic layer; and
laminating the second plastic layer to the second side of the substrate layer, using a second bonding layer between the substrate layer and the second plastic layer,
wherein the optical layer is selected from a group consisting of: a metallized layer, a printing ink, a pigment, a toner, and a lacquer layer.

30. The packaging article of claim 29, further comprising connecting a plurality of optical layers to at least one of the substrate layer, the first plastic layer, and the second plastic layer, wherein each optical layer is selected from the group consisting of: a metallized layer, a printing ink, a pigment, a toner, and a lacquer layer.
